(19) United States
(12) Patent Application Publication
(10) Pub. No.: US 2007/0064949 A1
(43) Pub. Date: Mar. 22, 2007

(54) METHOD AND APPARATUS FOR SENDING AND RECEIVING PLURALITY OF DATA STREAMS

(75) Inventors: Hyung-Nam Choi, Hamburg (DE); Michael Eckert, Braunschweig (DE); Martin Wuschke, Meine (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/468,858

(22) Filed: Aug. 31, 2006

(30) Foreign Application Priority Data
Sep. 9, 2005 (DE) 102005043001.5-35

(51) Int. Cl. H04K 1/00

(52) U.S. Cl. 380/270

(57) ABSTRACT

In a MIMO multi-antenna system, multiplexing is performed in accordance with a multiplexing rule stored in at least one multiplex file for multiplexing a plurality of data streams on to a plurality of transmit data streams.

### Cross-Reference to Related Application

This application claims priority to German Patent Application Serial No. 10 2005 043 001.5, which was filed Sep. 9, 2005, and is incorporated herein by reference in its entirety.

1. Field of the Invention

The invention relates to a method for transmitting a plurality of data streams, a method for demultiplexing transmit data streams received by means of a plurality of receiving antennas, a transmitting device for transmitting a plurality of data streams, a receiving device for demultiplexing transmit data streams received by means of a plurality of receiving antennas, and corresponding computer program elements.

2. Background of the Invention

Similar to a one-antenna system, it is desirable in a multi-antenna system which is used for transmitting different data streams, to adapt the data transmission flexibly to the respective transmission requirements and transmission conditions.

### BRIEF DESCRIPTION OF THE FIGURES

FIG. 1 shows a communication system according to an exemplary embodiment of the invention;

FIG. 2 shows a representation of a protocol structure of the UMTS air interface;

FIG. 3 shows a representation of a MIMO structure according to an exemplary embodiment of the invention;

FIG. 4 shows a block diagram of an uplink transmission scenario;

FIG. 5 shows a block diagram the mapping data streams from transport channels onto the physical channels;

FIG. 6 shows a block diagram of MIMO multiplexing according to a first exemplary embodiment of the invention; and

FIG. 7 shows a block diagram of MIMO multiplexing according to a second exemplary embodiment of the invention.

### DETAILED DESCRIPTION OF THE INVENTION

The current UMTS (Universal Mobile Telecommunications System) mobile radio communications standard, also called Release 6, allows maximum net transmission rates of 10 Mbps in the downlink direction of transmission (this means the direction of transmission from a base station, in each case allocated to a mobile radio communications terminal, to the mobile radio communications terminal in a mobile radio access network) and 2 Mbps in the uplink direction of transmission (this means the direction of transmission from a mobile radio communications terminal to a respective base station in the mobile radio access network). For the future development of the UMTS mobile radio communications system with regard to the improvement in the system capacity and the spectral efficiency, particularly for packet data applications, new techniques are currently being investigated in the 3GPP (3rd Generation Partnership Project) standardization body, for example higher modulation levels such as 64 QAM (Quadrature Amplitude Modulation) or 256 QAM, new multiple access method based on OFDM (Orthogonal Frequency Division Multiplexing) and/or MIMO (Multiple Input-Multiple Output). The aim is to distinctly increase the maximum net transmission rates in future up to 100 Mbps in the downlink direction of transmission and 50 Mbps in the uplink direction of transmission.

A MIMO communications system is usually a radio system which has a number of antennas both at the transmitter end and at the receiver end (for example up to four antennas at the transmitter end and/or up to four antennas at the receiver end), which are operated simultaneously, the antennas utilizing the same frequency channels for the data transmission. The advantage of such a multi-antenna system is, for example, that different data streams are transmitted in the same frequency band with a number of antennas at the transmitter. The data streams can subsequently be separated again in the receiver also by means of a number of antennas. This makes it possible to achieve a multiplication of the data rate. However, this gain is associated with an increased complexity in the signal processing, particularly at the receiver end.

In the 3GPP standardization body, only MIMO systems for the following application scenario are currently being investigated: the transmission direction considered is only the downlink (that is to say the transmitter is the base station at the network end and the receiver is the subscriber terminal), and the transmission data considered are only the data on the HS-DSCH (High Speed Downlink Shared Channel) transport channel.

With regard to a future application of a MIMO communication system also in the uplink direction of transmission and for other types and another number of transport channels, there is a requirement for a simple and cost-effective solution to such a scenario.

Various transmit diversity methods can be used for FDD (Frequency Division Duplex) and TDD (Time Division Duplex) radio transmission technologies. A UMTS system in which two transmitting antennas are used on the UMTS base station (node B) side in a multi-antenna system is described in the UMTS communication system Release 6.

Such transmit diversity methods are illustratively based on the transmitter sending to the receiver a number of statistically independent, that is to say uncorrelated copies of the same signal so that the signals arrive at the receiver on different propagation paths with different propagation times and attenuating influences. At the receiver, the two received signals are combined again to form a signal, for example, by detecting the stronger received signal in each case at defined times. In this manner, the fading influences, that is to say the weakening influences occurring due to the mobile radio channel, are reduced since the probability that the signal dips caused by fading occur simultaneously on the various propagation paths is relatively low.

According to an exemplary embodiment of the invention, a multi-antenna system via which a number of different data streams are transmitted is flexibly adapted to the respective transmission requirements and transmission conditions.

According to an exemplary embodiment of the invention, a method for transmitting a plurality of data streams via a plurality of transmitting antennas in a communication system having the plurality of transmitting antennas and a plurality of receiving antennas, wherein each data stream has at least one data packet, in which the data packets are multiplexed for transmitting the data packets via a respective transmitting antenna on to transmit data streams, wherein each transmit data stream is allocated to a transmitting antenna, the respective transmit data stream is transmitted via its associated transmitting antenna, and multiplexing is effected in accordance with a multiplexing rule stored in at least one multiplex file.

According to a further exemplary embodiment of the invention, a method for demultiplexing transmit data streams received via a plurality of receiving antennas is provided in a communications system having a plurality of transmitting antennas and the plurality of receiving antennas, in which the received transmit data streams are demultiplexed to form a plurality of data streams, wherein each data stream has at least one data packet, using demultiplexing information transmitted by the transmitter and received via the receiving antennas, which information specifies the manner in which the data streams have been multiplexed on to the transmit data streams.

According to a further exemplary embodiment of the invention, a transmitting device for transmitting a plurality of data streams via a plurality of transmitting antennas in a communication system having the plurality of transmitting antennas and a plurality of receiving antennas, wherein each data stream has at least one data packet, the device has a multiplexer for multiplexing the data packets on to transmit data streams. Furthermore, a multiplexer control unit is provided which controls the multiplexing in accordance with a multiplexing rule stored in at least one multiplex file.

According to a further exemplary embodiment of the invention, a receiving device for demultiplexing transmit data streams, received via a plurality of receiving antennas, is provided in a communication system having a plurality of transmitting antennas and the plurality of receiving antennas, the device has a demultiplexer for demultiplexing the received transmit data streams to form a plurality of data streams wherein each data stream has at least one data packet. Furthermore, a demultiplexer control unit is provided which controls the demultiplexing in accordance with demultiplexing information transmitted by the transmitter and received by means of the receiving antennas, in which a manner is specified, in which the data streams have been multiplexed on to the transmit data streams.

According to further exemplary embodiments of the invention, computer program elements are provided which, when executed by a processor, comprise a method described above in each case.

In an exemplary embodiment of the invention, an advantageous solution for the multiplexing, the transmission and the signaling of data in a mobile radio communications system, for example, according to UMTS, is provided with regard to a future application of MIMO also in the uplink direction of transmission and for other types, and another number of transport channels.

The multiplex file can be changed, that is to say it is modifiable, for example, depending on at least one change request transmitted by a receiver of the transmit data streams.

This makes it possible to take the current quality of a mobile radio channel into consideration in the context of multiplexing the data streams to be transmitted on to the transmit data streams, wherein a transmitting antenna or a subgroup of transmitting antennas is in each case allocated to each transmit data stream, for example each MIMO transmit data stream. Illustratively, a receiver of the transmit data streams in this case can determine the transmission characteristics of at least one mobile radio channel used for the data transmission and at least a part of the multiplex file can be determined depending on the transmission characteristics determined for the at least one mobile radio channel and, if necessary changed, if desired.

Both the method for transmitting and the method for demultiplexing can be performed in each case by a mobile radio communications terminal or a mobile radio base station, in other words, the method can be used both in the uplink direction of transmission and in the downlink direction of transmission so that the multiplexing information can be signaled in accordance with the invention by means of the multiplexing rule or, respectively, the demultiplexing information transmitted by the transmitter to the receiver, in each case for the uplink direction of transmission and for the downlink direction of transmission.

At least a part of the multiplex file or, respectively of the change in the multiplex file desired by means of a change request can be additionally determined depending on the quality of service (QoS) allocated to a respective data stream.

To each data stream at least one transport channel can be allocated, and to each transport channel, in turn, a multiplex file can be allocated. The transmit data streams can be MIMO transmit data streams, in which case, for example in a 3GPP mobile radio communications system, mapping of the transport channel on to the respective physical data transmission channel (mapping of the data streams on to the transmit data streams) is provided, taking into consideration the information in the multiplex file.

To each transmit data stream, a transport block table can be allocated which contains at least one transmission rate to be used for transmitting the transmit data stream.

According to another embodiment of the invention, it is provided to determine a maximum available transmission capacity per transmit data stream on the basis of the available transmitting power per transmitting antenna and the transmission characteristics determined for the at least one mobile radio channel of the respective transmitting antenna allocated to it and to perform the multiplexing, taking into consideration the maximum available transmission capacity per transmit data stream.

According to another embodiment of the invention, it is provided to perform a prioritization of the transmit data streams on the basis of the maximum available transmission capacity determined for each transmit data stream, wherein the highest priority is assigned to the transmit data stream having the greatest maximum available transmission capacity and wherein lower priorities are assigned to the other transmit data streams in accordance with their respective maximum available transmission capacities determined, wherein the number of priorities is less than or equal to the number of transmit data streams taken into consideration.

Illustratively, according to this embodiment of the invention, a ranking list of the priorities according to the ordered size of the maximum transmission capacity available in each case is formed.

Multiplexing can be performed by using a medium access control (MAC) device provided with a scheduler unit.

In this embodiment of the invention, it can be provided that the maximum available transmission capacity for each transmit data stream taken into consideration is provided to the scheduler unit and that the scheduler unit processes the transmit data streams depending on the priority of the respective transmit data stream beginning with the transmit data stream having the highest priority.

At least one transmit data stream can be deactivated and/or at least one transmit data stream can be reactivated, for example, due to a corresponding change in the multiplexing rule in the respective multiplex file.

Furthermore, the transmit data streams can be mapped on to at least one physical data channel.

For each transmit data stream, at least a part of the following information can be transmitted to the receiver of the transmit data stream, for example, as demultiplexing information to be used there:
a number of the transmit data stream; and/or
information about the modulation method(s) used and/or coding method(s); and/or
a transport block size indicator; and/or
a transport channel identity; and/or
a number of transport blocks per transport channel.

An embodiment of the invention can be used, for example, in a cellular mobile radio communications system, for example, in a cellular 3GPP mobile radio communications system or in a 3GPP2 mobile radio communications system, for example, in a UMTS mobile radio communications system or in a CDMA2000 mobile radio communications system or in a FOMA (Freedom of Mobile Multimedia Access) mobile radio communications system.

Illustratively, according to an exemplary embodiment of the invention, new parameters are defined with regard to the multiplexing of data streams on to transmit data streams in a multi-antenna communications system, i.e. in a communications system having a number of transmitting antennas and/or a plurality of receiving antennas by means of which, on the one hand, multiplexing of transport channels on to transmit data streams, for example, MIMO transmit data streams, and on the other hand, the discrete transmission rates on a transmit data stream, for example, a MIMO transmit data stream, are specified.

At the level of the physical layer, a new control unit is defined, for example, the data rate controller unit, the function of which is the determination of the maximum available transmission capacity per transmit data stream, for example, per MIMO transmit data stream, the internal prioritization of the transmit data streams (for example, MIMO transmit data streams) and the deactivation or, respectively reactivation, of transmit data streams (for example, MIMO transmit data streams) by means of the criteria predetermined by the mobile radio communications network.

With respect to signaling, control information is signaled, for example, per transmit data stream, for example per MIMO transmit data stream, on a physical control channel from transmitter to receiver for indicating the composition of the data of a transmit data stream, for example, of a MIMO transmit data stream, which are transmitted via associated physical data channels.

Advantages of embodiments of the invention are, for example:
the data transmission for multi-antenna systems can be performed efficiently depending on the quality of service (QoS) and the transmission characteristics of the mobile radio channel via which the transmit data streams are transmitted,
the application of multi-antenna systems in the downlink direction of transmission and in the uplink direction of transmission is supported,
the application of multi-antenna systems for all types and for an arbitrary number of transport channels is supported.

Exemplary embodiments of the invention are shown in the figures and will be explained in greater detail in the text which follows.

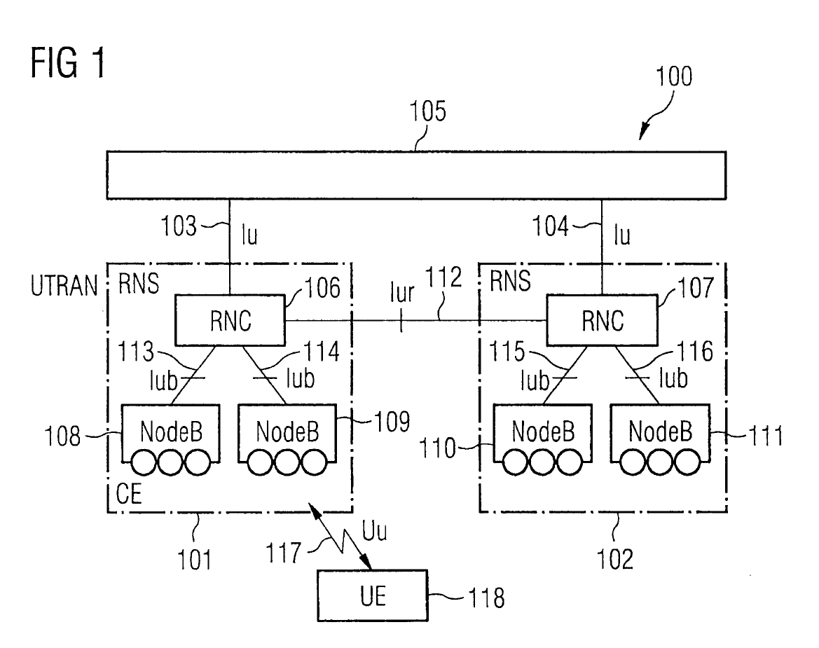

FIG. 1 shows a UMTS mobile communications system 100, for reasons of simpler representation, in particular, the components of the UMTS terrestrial radio access network (or UTRAN) which has a number of radio network subsystems (RNS) 101, 102 which in each case are connected to the UMTS core network (CN) 105 by means of a so-called Iu interface 103, 104. A radio network subsystem 101, 102 in each case has a radio network controller (RNC) 106, 107 and one or more UMTS base stations 108, 109, 110, 111 which are also called NodeB according to UMTS.

Within the terrestrial radio access network, the radio network controllers 106, 107 of the individual radio network subsystems 101, 102 are in each case connected to one another by means of a so-called Iur interface 112. Each radio network controller 106, 107 in each case monitors the allocation of mobile radio resources of all mobile radio cells in a radio network subsystem 101, 102.

A UMTS base station 108, 109, 110, 111 is in each case connected by means of a so-called Iub interface 113, 114, 115, 116 to a radio network controller 106, 107 allocated to the UMTS base station 108, 109, 110, 111.

Each UMTS base station 108, 109, 110, 111 illustratively spans one or more mobile radio cells (CE) within a radio network subsystem 101, 102 in radio terms. Between a respective UMTS base station 108, 109, 110, 111 and a user device 118 (user equipment, UE) also called mobile radio terminal in the text which follows, in a mobile radio cell, communications signals or respectively, data signals are transmitted by means of an air interface called Uu air interface 117 according to UMTS, for example, in accordance with a multiple access transmission method.

For example, according to the UMTS FDD (Frequency Division Duplex) mode, a separate signal transmission in the uplink (signal transmission from the mobile radio terminal 118 to the respective UMTS base station 108, 109, 110, 111) and the downlink direction (signal transmission from the respective associated UMTS base station 108, 109, 110, 111 to the mobile radio terminal 118) is achieved by a corresponding separate assignment of frequencies or frequency bands.

A number of subscribers or, in other words, a number of mobile radio terminals 118 activated or registered in the mobile radio access network, in the same mobile radio cell are separated from one another in signaling terms, for example, by means of orthogonal codes, particularly according to the so-called CDMA (Code Division Multiple Access) method.

In this context, it must be noted that, for reasons of simple representation, FIG. 1 shows only one mobile radio terminal 118. In general, however, an arbitrary number of mobile radio terminals 118 are provided in the mobile radio system 100.

The communication of a mobile radio terminal 118 with another communication device can be built up by means of a complete mobile radio communication link to another mobile radio terminal or, as an alternative, to a landline communication device.

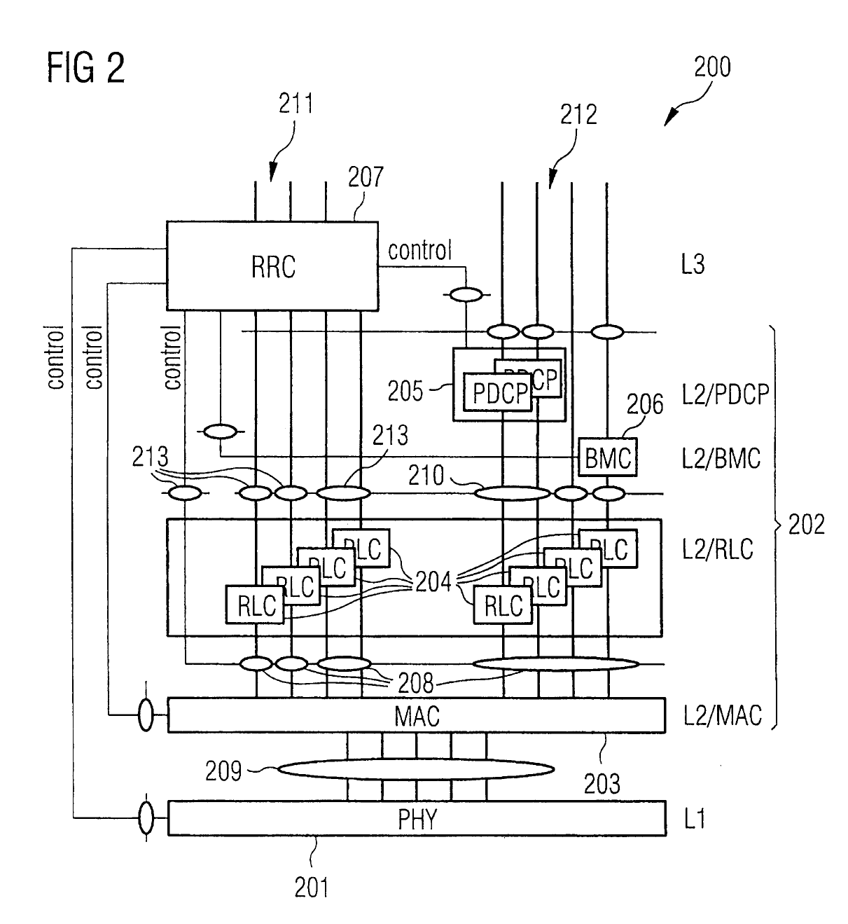

As shown in FIG. 2, the UMTS air interface 117 is logically structured in three protocol layers (symbolized by a protocol layer arrangement 200 in FIG. 2). The units (entities) guaranteeing and implementing the functionality of the respective protocol layers described in the text which follows are implemented both in the mobile radio terminal 118 and in the UMTS base station 108, 109, 110, 111 or, respectively, in the respective radio network controller 106, 107.

The lowest layer shown in FIG. 2 is the physical layer PHY 201 which represents the protocol layer 1 according to the OSI (Open System Interconnection) reference model according to ISO (International Standardization Organization).

The protocol layer arranged above the physical layer 201 is the data link layer 202 according to OSI reference model protocol layer 2 which, in turn, has a number of sub protocol layers, namely the Medium Access Control (MAC) protocol layer 203, the Radio Link Control (RLC) protocol layer 204, the Packet Data Convergence Protocol (PDCP) protocol layer 205 and the Broadcast/Multicast Control (BMC) protocol layer 206.

The top layer of the UMTS air interface Uu is the radio network layer (protocol layer 3 according to the OSI reference model) having the Radio Resource Control (RRC) protocol layer 207.

Each protocol layer 201, 202, 203, 204, 205, 206, 207 offers its services to the protocol layer above it via predetermined defined service access points.

To provide a better understanding of the protocol layer architecture, those access points are provided with generally used, unambiguous names such as, for example, logical channels 208 between the MAC protocol layer 203 and the RLC protocol layer 204, transport channels 209 between the physical layer 201 and the MAC protocol layer 203, radio bearers (RB) 210 between the RLC protocol layer 204 and the PDCP protocol layer 205 and the BMC protocol layer 206, respectively and signaling radio bearer (SRB) 213 between the RLC protocol layer 204 and the RRC protocol layer 207.

According to UMTS, the protocol structure 200 shown in FIG. 2 is divided not only horizontally into the protocol layers and units of the respective protocol layers described above but also vertically into a so-called control plane 211 (C plane), which contains parts of the physical layer 201, parts of the MAC protocol layer 203, parts of the RLC protocol layer 204 and the RRC protocol layer 207 and the user plane 212 (U plane) which contains parts of the physical layer 201, parts of the MAC protocol layer 203, parts of the RLC protocol layer 204, the PDCP protocol layer 205 and the BMC protocol layer 206.

The units of the control plane 211 are used for transmitting exclusively control data which are needed for constructing and clearing down and for maintaining a communication link whereas the units of the user plane 212 are used for transporting the actual user data.

Each protocol layer or, respectively, each unit (entity) of a respective protocol layer has certain predetermined functions during a mobile radio communication.

At the transmitter end, it is the task of the physical layer 201 or, respectively, the units of the physical layer 201 to ensure the reliable transmission of data coming from the MAC protocol layer 203 via the air interface 117. In this connection, the data are mapped on to physical channels (not shown in FIG. 2). The physical layer 201 offers its services to the MAC protocol layer 203 via transport channels 209 by means of which it is determined how and with what characteristic the data are to be transported via the air interface 117. The essential functions provided by the units of the physical layer 201 include the channel coding, the modulation and the CDMA code spreading. Correspondingly, the physical layer 201 or, respectively, the entities of the physical layer 201 perform the CDMA code despreading, the demodulation and the decoding of the received data at the receiver end and then forwards these to the MAC protocol layer 203 for further processing.

The MAC protocol layer 203 or, respectively, the units of the MAC protocol layer 203 offer(s) its or their services to the RLC protocol layer 204 by means of logic channels 208 as service access points by means of which the file type of the transported data is characterized. The task of the MAC protocol layer 203 in the transmitter, i.e. in the data transmission in the uplink direction in the mobile radio terminal 118 is especially to map the data which are present on a logical channel 208 above the MAC protocol layer 203 on to the transport channels 209 of the physical layer 201. For this purpose, the physical layer 201 offers discrete transmission rates to the transport channels 209. An important function of the MAC protocol layer 203 or, respectively of the entities of the MAC protocol layer 203 in the mobile radio terminal 118 in the transmitting case is, therefore, the selection of a suitable transport format (TF) for each configured transport channel depending on the current data transmission rate in each case and the respective data priority of the logical channels 208 which are mapped on to the respective transport channel 209, and the available transmitting power of the mobile radio terminal 118 (UE). Among other things, it is specified in a transport format how many MAC data packet units, called transport blocks, are transmitted, or in other words, transferred, to the physical layer 201 per transmission time interval (TTI) via the transport channel 209. Permissible transport formats and the permissible combinations of transport formats of the various transport channels 209 are signaled to the mobile radio terminal 118 by the radio network controller 106, 107 during the setting-up of a communication link in the form of the so-called uplink TFCS (Transport Format Combination Set, the number of permitted transport format combinations). In the receiver, the transport blocks received on the transport channels 209 are again distributed to the logical channels 208 by the units of the MAC protocol layer 203.

The MAC protocol layer or, respectively, the units of the MAC protocol layer 203 has or have normally three logical units. The so-called MAC-d (MAC-dedicated) unit deals with the useful data and the control data which are mapped via the corresponding dedicated logical channels DTCH (Dedicated Traffic Channel) and DCCH (Dedicated Control Channel) on to the dedicated transport channels DCH (Dedicated Channel). The MAC-c/sh unit (MAC control/shared unit) deals with the user data and the control data of logical channels 208 which are mapped on to the common transport channels 209 such as, for example, the common transport channel RACH (Random Access Channel) in the uplink direction or the common transport channel FACH (Forward Access Channel) in the downlink direction. The MAC-b (MAC broadcast) unit only deals with the mobile radio cell-related system information which is mapped on to the transport channel BCH (Broadcast Channel) via the logical channel BCCH (Broadcast Control Channel) and is transmitted to all mobile radio terminals 118 in the respective mobile radio cell by broadcasting.

The RLC protocol layer 204 or, respectively, the units of the RLC protocol layer 204 are used for offering their services to the RLC protocol layer 207 by means of signaling radio bearer (SRB) 213 as service access points and to the PDCP protocol layer 205 and the BMC protocol layer 206 by means of radio bearer (RB) 210 as service access points. The signaling radio bearer and the radio bearer characterize how the RLC protocol layer 204 has to handle the data packets. For this purpose, the transmission mode, for example, is specified by the RRC protocol layer 207 for each configured signaling radio bearer or radio bearer, respectively. According to UMTS, the following transmission modes are provided:
Transparent mode (TM),
Unacknowledged mode (UM), or
Acknowledged mode (AM).

The RLC protocol layer 204 is modeled in such a way that there is one independent RLC entity per radio bearer or signaling radio bearer, respectively. Furthermore, it is the task of the RLC protocol layer or, respectively, its entities 204 in the transmitting device to divide or assemble into data packets, the user data and signaling data of radio bearers or signaling radio bearers, respectively. The RLC protocol layer 204 transfers the data packets produced after the dividing or assembling to the MAC protocol layer 203 for further transport or for further processing, respectively.

The PDCP protocol layer 205 or the units of the PDCP protocol layer 205, respectively is or are set up for transmitting or receiving, respectively, data of the so-called packet switched (PS) domain. The main function of the PDCP protocol layer 205 is the compression or decompression, respectively, of the IP (Internet Protocol) header information.

The BMC protocol layer 206 or its entities, respectively, is or are used for transmitting or receiving, respectively, so-called cell broadcast messages via the air interface.

The RRC protocol layer 207 or the entities of the RRC protocol layer 207, respectively is or are responsible for the setting up and the clearing down and the reconfiguration of physical channels, transport channels 209, logical channels 208, signaling radio bearers 213 and radio bearers 210 and for negotiating all parameters of the protocol layer 1, i.e. of the physical layer 201 and of the protocol layer 2. For this purpose, the RRC units, i.e. the units of the RRC protocol layer 207 in the radio network controller 106, 107 and the respective mobile radio terminal 118 exchange corresponding RRC messages via the signaling radio bearers 213.

The further characteristics of the MIMO communications systems hitherto considered are:
1, 2 or 4 antennas in each case on the NodeB side and on the side of the mobile radio communications terminal user equipment (UE) side.
Radio transmission technologies FDD (Frequency Division Duplex) and TDD (Time Division Duplex).
On the transmitter side, i.e. on the side of NodeB, the data of the HS-DSCH transport channel to be transmitted are divided into a plurality of data streams.
The individual data streams are channel coded, modulated and spread in the physical protocol layer.
The individual data streams are then transmitted via an individual transmitting antenna, or, respectively, via a subgroup of transmitting antennas, to the receiver, in the present case the mobile radio communications terminal (User Equipment (UE)) by means of the air interface.
The receiver determines the quality of the received data per data stream or, respectively, per transmitting antenna on the basis of the signal/noise ratio (SNR) and signals the quality to the transmitter in the form of quality information.
On the basis of the received quality, the transmitter adapts the channel coding and modulation for the respective data stream for the subsequent data transmission.
In a bad case of a highly disturbed channel, a data stream or the associated transmitting antenna(s) is/are temporarily switched off so that the corresponding data stream(s) is/are no longer transmitted temporarily.

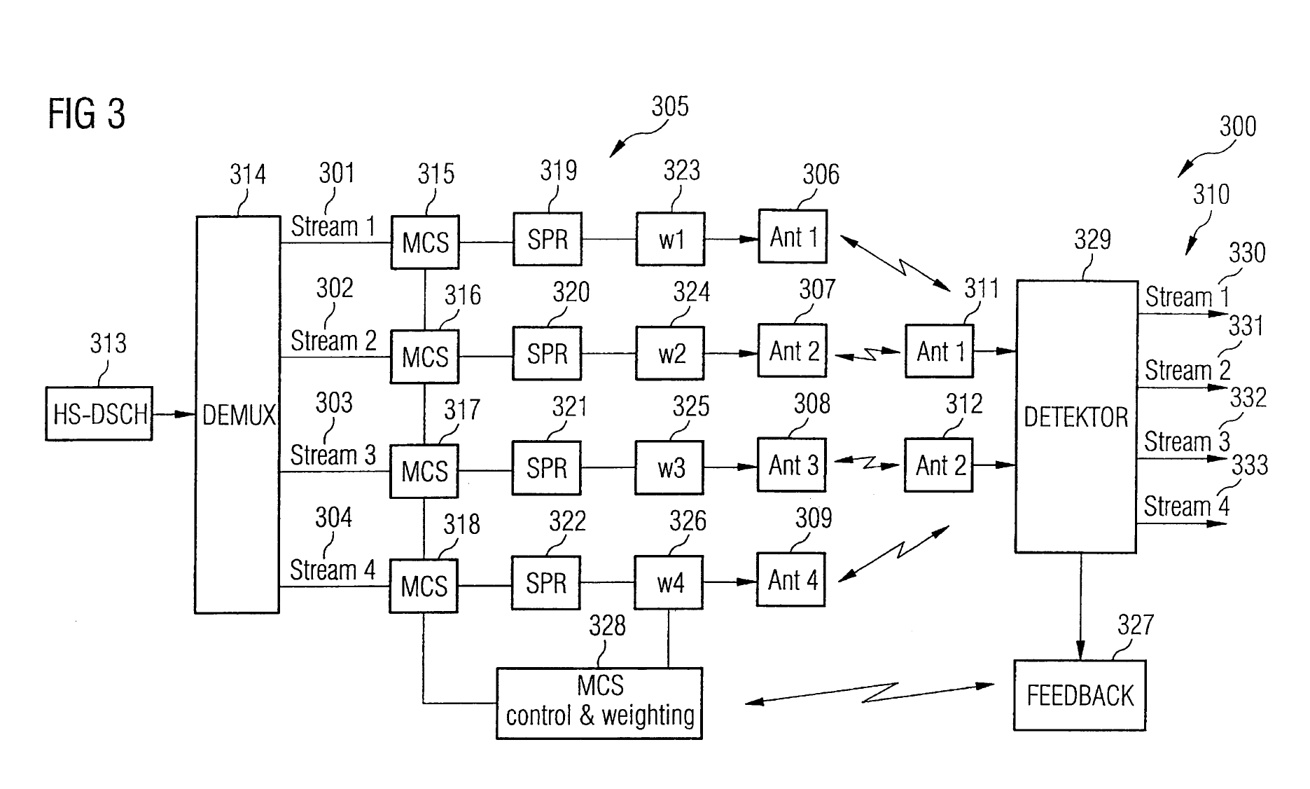

FIG. 3 shows a MIMO mobile radio communications system 300.

Without restriction of general validity, FIG. 3 shows a configuration for FDD with four data streams, also called streams (stream 1 to stream 4) 301, 302, 303, 304 in the text which follows, with four transmitting antennas on the side of the base station 305, 108, 109, 110, 111, namely a first transmitting antenna 306, a second transmitting antenna 307, a third transmitting antenna 308 and a fourth transmitting antenna 309 and with two receiving antennas on the side of the mobile radio communications terminal 310, 118 namely a first receiving antenna 311 and a second receiving antenna 312. In the transmitter, i.e. in other words, in the UMTS base station (NodeB) 305, 108, 109, 110, 111 the data on the HS-DSCH transport channel 313 are uniformly divided into four data streams, namely streams 301, 302, 303, 304, by means of a demultiplexer 314. Following that, the data of the individual data streams are separately channel-coded and modulated in a manner described above in the physical layer (symbolized in FIG. 3 by blocks MCS 315, 316, 317, 318).

After that, the channel-coded and modulated data streams are spread, again separately (symbolized by means of blocks SPR 319, 320, 321, 322 in FIG. 3) and amplified in power (symbolized by means of blocks w1, w2, w3, w4, 323, 324, 325, 326 in FIG. 3). At the receiver end, i.e. in the mobile radio communications terminal 310, 118, the quality of the received data is determined by the latter, for example, by a processor of the mobile radio communications terminal 310, 318 for each data stream or, respectively, for each transmitting antenna on the basis of the signal/noise ratio (SNR) determined, and the signal quality determined is signaled to the base station 305 (symbolized by the FEEDBACK block 327 in FIG. 3).

On the basis of the received signal quality transmitted, the UMTS base station 305 adapts the channel coding and modulation 315, 316, 317, 318 and the power setting w1, w2, w3, w4, 323, 324, 325, 326. This adaptation is symbolized in FIG. 3 by means of the “MCS Control and Weighting” block 328. The adaptation is individual for the respective data stream for the subsequent data transmission.

The mobile radio communications terminal 310, 118 also has a detector and demultiplexer 329 coupled to the two receiving antennas 311, 312, which demultiplexes the data streams of the physical channel received by means of the receiving antennas 311, 312 to the data streams Stream 1 to Stream 4, 330, 331, 332, 333 of the transport channel.

With regard to the future UMTS evolution for improving the packet data transmission in the downlink direction of transmission and uplink direction of transmission, it is desirable that the application of MIMO can also be extended to other transport channels than the HS-DSCH, i.e. also to common and dedicated transport channels. This leads to data from a multiplicity of transport channels then having to be multiplexed on to a multiplicity of independent MIMO data streams in the physical layer.

Having regard to this scheduling, a solution can be seen in statically configuring the transport channels for each of the data streams in the physical layer, i.e. a transport channel is statically multiplexed onto a particular data stream in this case and separate scheduling is performed for each of these data streams.

The disadvantageous factor in this procedure is, for example, that, as a result it is not easily possible to respond to the dynamic transmission characteristics of the mobile radio channel. The cases should be taken into consideration when due to a greatly disturbed mobile radio channel, for example a data stream, or respectively, the associated transmitting antenna(s) is/are temporarily switched off so that the corresponding data stream can no longer be transmitted temporarily. On the other hand, it should be ensured that the data of a service are transmitted via the mobile radio channel in accordance with its QoS (quality of service) profile. Furthermore, a static configuration is relatively inefficient with respect to the utilization of the transmission capacity, i.e. if, for example, there are temporarily no data present for transmission on a transport channel, then the associate data stream is not utilized.

Against this background, corresponding changes in the multiplexing, in the transmission and signaling of data are provided in accordance with the invention in the application of a multi-antenna system, for example, in a MIMO multi-antenna system.

In the text which follows, the multiplexing, the transmission and the signaling of data according to a UMTS communications system according to Release 6 is shown by way of example with reference to an uplink transmission scenario with dedicated transport channels to provide easier understanding of the exemplary embodiments of the invention.

It must be pointed out that other cellular mobile radio communications systems or also non-cellular mobile radio communications systems can also be used in alternative embodiments of the invention and, in particular, the downlink direction of transmission can also be implemented as part of an alternative exemplary embodiment. In addition, the invention is not restricted to a particular transport channel to be used.

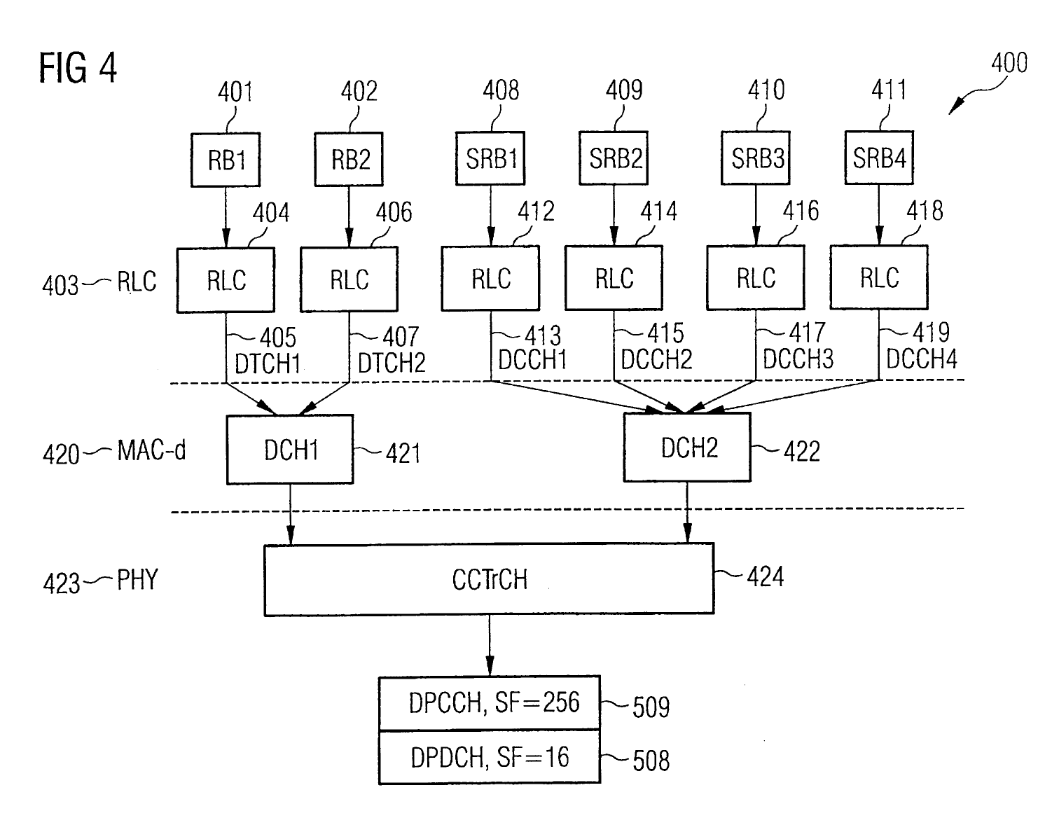

In FIG. 4, the uplink transmission scenario is illustrated in a block diagram 400.

An exemplary embodiment is considered in which a mobile radio communications terminal, also called user equipment (UE) in the text which follows in a mobile radio cell uses two packet services in parallel in the uplink direction of transmission, for example, for interactive games on the Internet and for streaming video data.

The individual protocol layers were configured for the uplink, i.e. for the uplink direction of transmission by means of the radio network controller (RNC), in such a manner that the two services can be utilized with the quality of service provided for the duration of the mobile radio link. The configuration specified by the RNC was signaled to the RRC layer, or, respectively, the RRC protocol unit in the user equipment UE by means of a corresponding RRC protocol message. In the U plane, two radio bearers are specified, namely a first radio bearer (RBl) 401 for the communications service “interactive games on the Internet” and a second radio bearer (RB2) 402 for the communications service “streaming of video data”, via which the user data of the respective packet-switched communications service are transmitted.

Each radio bearer 401, 402 is mapped in the RLC layer 403 or in the unit implementing it, respectively, on to a respective RLC entity, also called RLC part-protocol unit in the text which follows and by means of the latter on to a respective logical traffic channel DTCH (Dedicated Traffic Channel).

In the exemplary embodiment shown in FIG. 4, a first RLC part-protocol unit 404 is provided for the first radio bearer 401 which is mapped on to a first DTCH channel (DTCH1) 405. Furthermore, a second RLC part-protocol unit 406 is provided for mapping the second radio bearer 402 on to a second DTCH channel (DTCH2) 407. In the C plane, four signaling radio bearers, namely a first signaling radio bearer (SRB1) 408, a second signaling radio bearer (SRB2) 409, a third signaling radio bearer (SRB3) 410 and a fourth signaling radio bearer (SRB4) 411 are specified due to the different type of control messages, which are in each case mapped on to a respective logical control channel DCCH (Dedicated Control Channel) by means of a respective RLC part-protocol unit in the RLC layer 403. More precisely, a third RLC part-protocol unit 412 is provided for mapping the first signaling radio bearer 408 on to a first DCCH channel (DCCH1) 413. Furthermore a fourth RLC part-protocol unit 414 is provided for mapping the second signaling radio bearer 409 on to a second DCCH channel (DCCH2) 415. A fifth RLC part-protocol unit 416 is provided for mapping the third signaling radio bearer 410 on to a third DCCH channel (DCCH3) 417, and a sixth RLC part-protocol unit 418 is provided for mapping the fourth signaling radio bearer 411 on to a fourth DCCH channel (DCCH4) 419.

In a MAC-d protocol unit 420 two transport channels are configured, namely a first transport channel (Dedicated Channel, DCH1) 421 and a second transport channel (DCH2) 422, wherein the two logical traffic channels DTCH1 405 and DTCH2 407 are multiplexed on to the first transport channel DCH1 421 in the U plane and the four logical control channels DCCH1 413, DCCH2 415, DCCH3 417 and DCCH4 419, are multiplexed on to the second transport channel DCH2 422 in the C plane.

In the protocol unit of the physical layer 423, illustratively in the physical layer, the data of the two transport channels 421, 422 are channel-coded and multiplexed on to a mobile radio time frame or data stream CCTrCH, respectively (Coded Composite Transport Channel) 424 with a length of 10 ms. On the basis of the mobile radio transmission technology FDD, the data on the CCTrCH, after having been spread and modulated, are transmitted via the Dedicated Physical Data Channel (DPDCH) with a spreading factor SF=16 via the air interface to the terrestral radio access network (UTRAN). Specific control information from the physical layer 423 is transmitted parallel thereto on the dedicated physical control channel (DPCCH) with a spreading factor of SF=256, so that the physical layer 423 is the UMTS base station 305, 108, 109, 110, 111, is also able to correctly decode the data of the DPDCH after the control information has been decoded on the DPCCH.

It is a task of the MAC-d protocol unit 420 in the mobile radio communications terminal 310, 118 to perform the scheduling of the data on the basis of the respective TFC selection method, i.e. to select a suitable transport format for the configured transport channels DCH1 421 and DCH2 422 at defined times depending on the instantaneous transmission rate and the data priority of the respective logical channels which are mapped on to these transport channels, and depending on the available transmitting power of the mobile radio communications terminal 310, 118. The scheduling process here ensures that the data of a communication service are transmitted via the air interface in accordance with its QoS profile. A transport format combination TFC represents a combination of transport formats allowed by the RNC for each configured transport channel. The permissible combinations of transport formats of the various transport channels are signaled to the mobile radio communications terminal by the RNC when the connection is set up.

In the exemplary embodiment shown in FIG. 4, it is assumed without restricting its general validity, that five transport formats TFO, TF1, TF2, TF3, TF4 are configured for the first transport channel DCH1 421 and two transport formats TFO and TF1 are configured for the second transport channel DCH2 422. It is also assumed that the total set of permissible transport format combinations TFCS (Transport Format Combination Set) consists of ten TFCs (TFCO to TFC9).

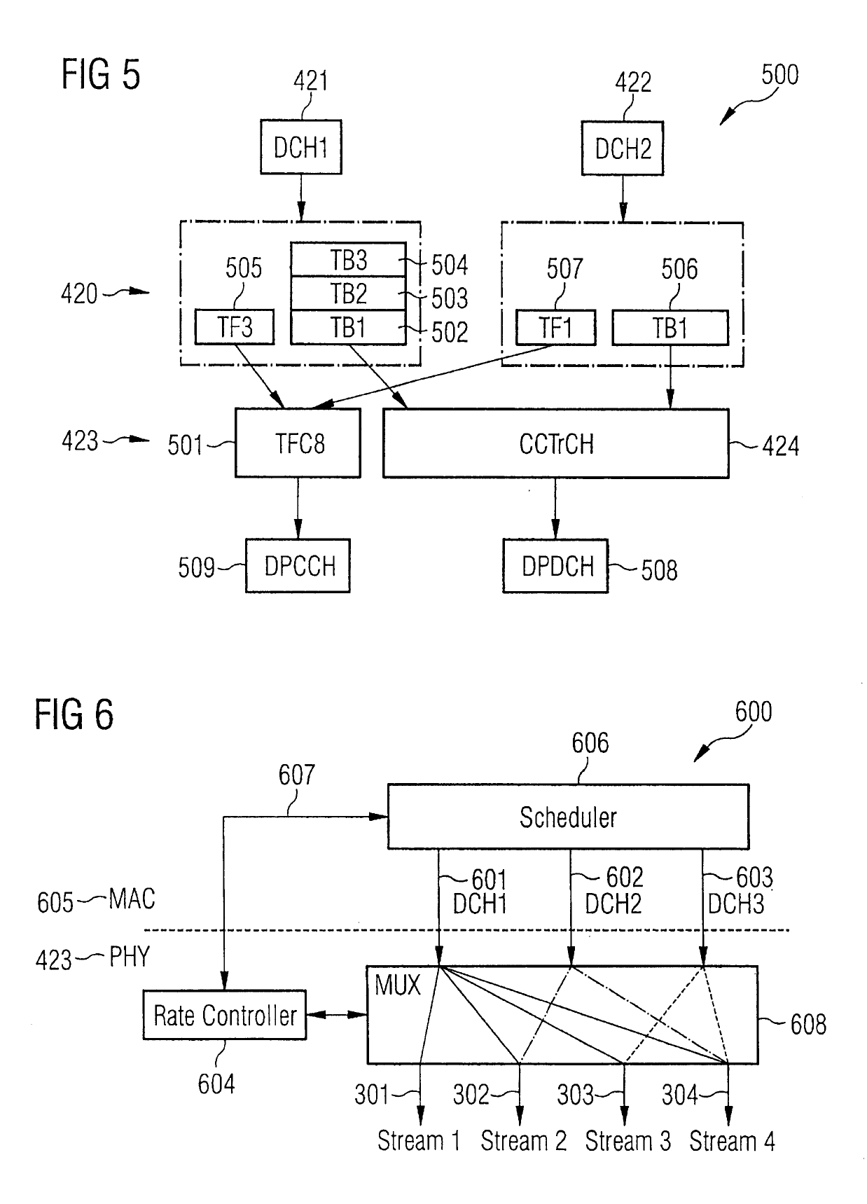

FIG. 5 shows in a block diagram 500, an example in which the MAC-d protocol unit 420 has selected transport format combination TFC8 501. Transport format combination TFC8 (TFC8=(TF3, TF1)) here specifies that the respective proportions of the coded data are transmitted on the CCTrCH 424 by three transport blocks (namely a first transport block TB1 502, a second transport block TB2 503, a third transport block TB3 504 of the first transport channel 421) of the first transport channel DCH1 (=TF3 505) and by one transport block, namely a first transport block 506 TB1 of the second transport channel DCH2 422 (=TF1 507). For the physical layer 423 in the UMTS base station to be able to correctly decode the data on the DPDCH 508 the transport format combination TFC8 501 used on the CCTrCH 424 is signaled as control information on the DPCCH 509.

In the text which follows, methods for the multiplexing, the transmission and the signaling of data in the UMTS communications system described above are proposed which are advantageous for multi-antenna systems. The embodiments described in the text which follows contain, in particular, the following features:

According to the embodiments of the invention, the following new parameters are defined as part of the multiplexing:
For each transport channel 421, 422, a “MIMO stream multiplexing list” is configured as multiplex rule in a multiplex file unambiguously allocated to a respective transport channel 421, 422.

This parameter specifies the MIMO transmit data streams on to which the data of this transport channel 421, 422 are multiplexed or not.

The “MIMO Stream Multiplexing List” is defined as bit stream with the following notation:

“Stream 1, Stream 2, ..., Stream n” in the case of n data streams.

With a first bit value of “1”, the respective transport channel is multiplexed on to the data stream, with a second bit value of “0”, there is no multiplexing of the respective transport channel on to the MIMO transmit data stream. The configuration of this parameter is effected in accordance with an embodiment of the invention by the radio network, for example, by the UMTS base station or by the RNC, and should be adaptive depending on the quality of service of the data which are in each case transmitted via this transport channel 421, 422, and on the dynamic transmission characteristics of the radio channel. This parameter enables the data of a transport channel 421, 422 to be transmitted via the air interface via a number of parallel data streams.
For each MIMO transmit data stream, a transport block table MTT is configured. The transport block table MTT is used for specifying the discrete transmission rates of the respective MIMO transmit data stream.

As part of the scheduling, in order to perform the scheduling in the MAC layer, a new control unit is defined in the physical layer PHY, for example, called a MIMO rate controller, which has the following function or, in other words, which is set up for implementing the functions described in the text which follows:
The maximum transmission capacity currently available per MIMO transmit data stream is determined on the basis of the available transmitting power per transmitting antenna and the channel quality signaled by the receiver for the respective transmitting antenna.
On the basis of the transmission capacity determined for each MIMO transmit data stream, the MIMO transmit data streams are internally prioritized, i.e. the MIMO transmit data stream having their greatest transmission capacity receives the highest priority. Correspondingly, the data stream having the lowest transmission capacity receives the lowest priority. In this arrangement, the number of priority levels is, for example, less than or equal to the number of MIMO transmit data streams. In other words, this means that the priority levels are determined in accordance with the respective maximum available transmission capacity of the respective transmitting antenna.
The information about the maximum transmission capacity currently available per MIMO transmit data stream and the prioritization of the MIMO transmit data streams is signaled to the scheduler unit in the MAC layer so that the latter processes the MIMO transmit data streams depending on their respective priority during the scheduling, i.e. firstly the data stream having the highest priority is processed, then the MIMO transmit data stream having the second-highest priority, etc.
On the basis of a threshold predetermined by the radio network (SNR, Block Error Rate (BLER), Bit Error Rate (BER), etc.), a decision is made whether a MIMO transmit data stream is temporarily deactivated or reactivated, respectively.

During the signaling, it is assumed that the data of a MIMO transmit data stream are mapped on to one or more physical data channels. To signal the composition of the data on these physical data channels to the receiver, it is also assumed that control information for each MIMO transmit data stream is transmitted on an associated physical control channel.

According to the embodiments of the invention presented here, the following control information is to be signaled on a physical control channel from transmitter to receiver for each MIMO transmit data stream:
the number of the MIMO transmit data stream (Stream#);
a the modulation method(s) and/or coding method(s) (MCS) used;
a transport block size indicator (TB index);
a transport channel identity (TrCH-Id);
a number of transport blocks per transport channel (N).

Without restriction of general validity, the following configuration is assumed in the following embodiments of the invention.

A downlink transmission having the MIMO structure according to FIG. 3 is assumed, i.e. with four data streams (stream 1 to stream 4) 301, 302, 303, 304, four transmitting antennas 306, 307, 308, 309 at the NodeB end 305 and two receiving antennas 311, 312 at the UE end 310.

It must be pointed out that other configurations of data streams and transmitting antennas at the NodeB end and receiving antennas on the UE end can also be assumed in alternative embodiments of the invention. For example, a MIMO structure with two data streams and four transmitting antennas can be assumed at the NodeB end in which one data stream is in each case allocated to one subgroup of two transmitting antennas. Furthermore, it can be assumed that there is only one or there are four receiving antennas at the UE end.

Three dedicated transport channels are configured, namely a first transport channel DCH1, a second transport channel DCH2 and a third transport channel DCH3, having the following transport formats:
DCH1:
   TF 0=(0×336 bits),
   TF 1=(1×336 bits),
   TF 2=(2×336 bits),
   TF 3=(3×336 bits),
   TF 4=(4×336 bits),
DCH2:
   TF 0=(0×336 bits),
   TF 1=(1×336 bits),
   TF 2=(2×336 bits),
   TF 3=(3×336 bits),
DCH3:
   TF 0=(0×148 bits),
   TF 1=(1×148 bits),

According to these embodiments, a “MIMO Stream Multiplexing List” is configured for each dedicated transport channel as multiplexing rule, i.e.
DCH1:
   (1, 1, 1, 1),
   i.e. this transport channel is multiplexed on to all four MIMO transmit data streams;
DCH2:
   (0, 1, 0, 1),
   i.e. this transport channel is multiplexed on to data streams Stream 2 302 and Stream 4 304; and
DCH3:
   (0, 0, 1, 1)
   i.e. this transport channel is multiplexed on to data streams Stream 3 303 and Stream 4 304.

The transmission time interval TTI for all transport channels is assumed to be 10 ms, wherein any other suitable transmission time interval can be used in alternative embodiments of the invention.

For all four MIMO transmit data streams 301, 302, 303, 304 (Stream 1 to Stream 4), the same transport block table MTT is configured which has the following values:
TB#0=0 bits;
TB#1=400 bits;
TB#2=800 bits;
TB#3=1200 bits;
TB#4=1800 bits;
TB#5=2400 bits.

In this connection, it should be noted that different transport block tables can also be provided for the respective different MIMO transmit data streams.

The data of a MIMO transmit data stream 301, 302, 303, 304 are mapped on to physical data channels. To signal the composition of the data of these physical data channels to the mobile radio communications terminal, the following control information is transmitted on the associated physical control channel for each MIMO transmit data stream 301, 302, 303, 304:
number of the MIMO data stream (Stream#);
modulation methods and/or coding methods (MCS) used;
the transport block size indicator (TB index);
the transport channel identity (TrCH-Id);
the number of transport blocks per transport channel (N).

In the text which follows, the multiplexing, the transmission and the signaling of data are described in accordance with the exemplary embodiment shown in a block diagram 600 in FIG. 6.

The case is considered in which the following set of data packets (=transport blocks) are present for transmission on each transport channel.
on the first transport channel 601 DCH1:
   2×336 bits=(TF2);
on the second transport channel 602 DCH1:
   3×336 bits=(TF3);
on the third transport channel 603 DCH3:
   1×148 bits=(TF1).

A data rate controller unit 604 which is arranged in the physical protocol layer 423 determines the maximum transmission capacity currently available per MIMO transmit data stream on the basis of the available transmitting power per transmitting antenna and the channel quality for the respective transmitting antenna signaled by the mobile radio communications terminal, as follows:
first MIMO transmit data stream 301 Stream 1:
   1800 bits maximum, i.e. TB#4;
second MIMO transmit data stream 302 Stream 2:
   800 bits maximum, i.e. TB#2;
third MIMO transmit data stream 303 Stream 3:
   1200 bits maximum, i.e. TB#3;
fourth MIMO transmit data stream 304 Stream 4:
   400 bits maximum, i.e. TB#1.

Without restricting the general validity, the data rate controller unit 604 (Rate Controller) performs the following prioritization of the MIMO transmit data streams 301, 302, 303, 304 on the basis of the transmission capacity determined for each MIMO transmit data stream 301, 302, 303, 304:
first priority 1:
   first MIMO transmit data stream 301 Stream 1;
second priority 2:
   third MIMO transmit data stream 303 Stream 3;
third priority 3:
   second MIMO transmit data stream 302 Stream 2;
fourth priority 4:
   fourth MIMO transmit data stream 304 Stream 4.

The data rate controller unit 604 signals the information about the maximum transmission capacity currently available per MIMO data stream 607 and about the prioritization of the MIMO transmit data streams to a scheduler unit 606 provided in the MAC protocol layer unit 605 so that the scheduler unit 606 processes the MIMO transmit data streams 301, 302, 303, 304 depending on their priority during the scheduling.

The scheduler unit 606 performs the scheduling and distributes the data packets of the individual transport channels to the MIMO transmit data streams 301, 302, 303, 304, taking into consideration the permitted multiplexing options according to the present embodiment, as follows:
first MIMO transmit data stream Stream 1:
   two data packets from the first transport channel 601 DCH1;
second MIMO transmit data stream Stream 2:
   two data packets from the second transport channel 602 DCH2;
third MIMO transmit data stream Stream 3:
   one data packet from the third transport channel 603 DCH3;
fourth MIMO transmit data stream Stream 4:
   one data packet from the second transport channel 602 DCH2.

The data of each MIMO transmit data stream 301, 302, 303, 304 are sent to the mobile radio communications terminal on physical data channels. To signal the composition of the data on these physical data channels to the mobile radio communications terminal, the following control information is transmitted for each MIMO transmit data stream 301, 302, 303, 304 on the associated physical control channel:
first control channel #1:
   Stream#1, MCS, TB#2, DCH1, 2;
second control channel #2:
   Stream#2, MCS, TB#2, DCH2, 2;
third control channel #3:
   Stream#3, MCS, TB#1, DCH3, 1;
fourth control channel #4:
   Stream#4, MCS, TB#1, DCH2, 1.

The data are mapped on to the MIMO transmit data streams by means of a multiplexer 608 by controlling the data rate controller unit 604, using the control by the scheduler unit 606 as described above.

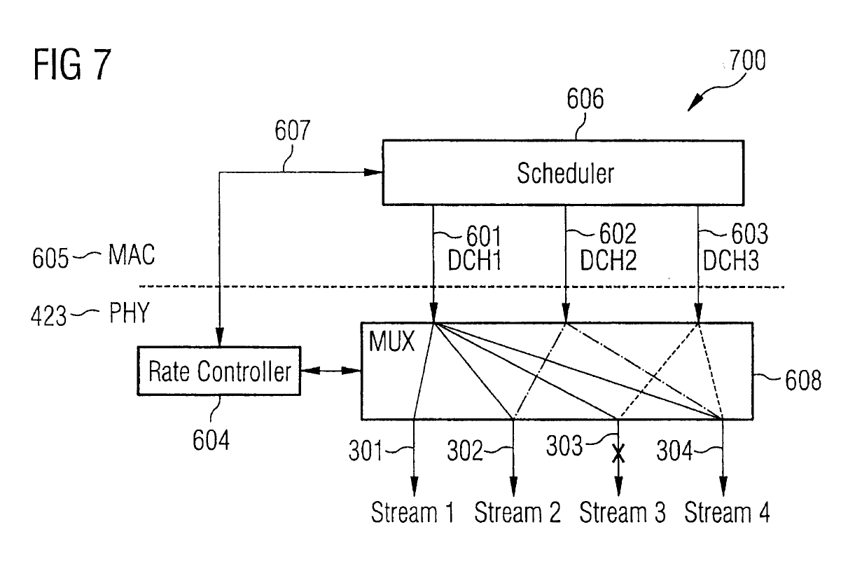

In the text which follows, the multiplexing, the transmission and the signaling of data according to a second exemplary embodiment shown in a block diagram 700 in FIG. 7 is described.

The case is considered in which the third transmitting antenna and the corresponding third MIMO transmit data stream 303 have been temporarily deactivated by the data rate controller unit 604 due to a very disturbed radio channel. The following set of data packets (=transport blocks) is currently available for transmission on each transport channel:
first transport channel 601 DCH1:
   2×336 bits=(TF2);
second transport channel 602 DCH2:
   3×336 bits=(TF3);
third transport channel 603 DCH3:
   1×148 bits=(TF1).

The data rate controller unit 604 determines the maximum transmission capacity currently available per MIMO transmit data stream 301, 302, 303, 304 on the basis of the available transmitting power per transmitting antenna and the channel quality for the respective transmitting antenna signaled by the mobile radio communications terminal as follows:
first MIMO transmit data stream 301 Stream 1:
   1200 bits maximum, i.e. TB#3;
second MIMO transmit data stream 302 Stream 2:
   800 bits maximum, i.e. TB#2;
fourth MIMO transmit data stream 304 Stream 4:
   800 bits maximum, i.e. TB#2.

The data rate controller unit 604 performs the following prioritization of the MIMO transmit data streams 301, 302, 303, 304 on the basis of the transmission capacity determined per MIMO transmit data stream 301, 302, 303, 304:
first priority 1:
   first MIMO transmit data stream 301 Stream 1;
second priority 2:
   second MIMO transmit data stream 302 Stream 2,
   fourth MIMO transmit data stream 304 Stream 4.

The data rate controller unit 604 signals the information about the maximum transmission capacity currently available per MIMO transmit data stream and the prioritization of the MIMO transmit data streams to the scheduler unit 606 in the MAC layer 605 so that the former processes the MIMO transmit data streams depending on their priority during the scheduling. The scheduler unit 606 performs the scheduling and distributes the data packets of the individual transport channels 601, 602, 603 to the MIMO transmit data streams 301, 302, 303, 304 taking into consideration the permitted multiplexing options, as follows:
first MIMO transmit data stream 301 Stream 1:
   two data packets from the first transport channel 601 DCH1;
second MIMO transmit data stream 302 Stream 2:
   two data packets from the second transport channel 602 DCH2;
fourth MIMO transmit data stream 304 Stream 4:
   one data packet from the second transport channel 602 DCH2 and one data packet from the third transport channel 603 DCH3.

The data of each MIMO transmit data stream 301, 302, 304 are sent to the mobile radio communications terminal on physical data channels. To signal the composition of the data on these physical data channels to the mobile radio communications terminal, the following control information is transmitted for each MIMO transmit data stream 301, 302, 304 on the associated physical control channel:
first control channel #1:
   Stream#1, MCS, TB#2, DCH1, 2;
second control channel #2:
   Stream#2, MCS, TB#2, DCH2, 2;
fourth control channel #4:
   Stream#4, MCS, TB#2, DCH2, 1, DCH3, 1.

1-26. (canceled)

27. A method for transmitting a plurality of data streams, wherein at least one transport channel is allocated to each data stream and each data stream has at least one data packet, via a plurality of transmitting antennas in a communication system having the plurality of transmitting antennas and a plurality of receiving antennas, comprising:
multiplexing the data packets for transmission via a respective transmitting antenna on to transmit data streams, wherein each transmit data stream is allocated to a transmitting antenna, the respective transmit data stream is transmitted via its associated transmitting antenna, and the multiplexing is effected in accordance with a multiplexing rule stored in at least one multiplex file.

28. The method as claimed in claim 27, further comprising changing the multiplex file.

29. The method as claimed in claim 27, further comprising changing the multiplex file depending on at least one change request transmitted by a receiver of the transmit data streams.

30. The method as claimed in claim 27, being performed by a mobile radio communications terminal.

31. The method as claimed in claim 27, being performed by a mobile radio base station.

32. The method as claimed in claim 27, further comprising:
determining transmission characteristics of at least one mobile radio channel used for data transmission by a receiver of the transmit data streams; and
determining at least a part of the multiplex file depending on the transmission characteristics determined for the at least one mobile radio channel.

33. The method as claimed in claim 32, further comprising determining at least a part of the multiplex file additionally depending on the quality of service allocated to a respective data stream.

34. The method as claimed in claim 27, further comprising allocating a multiplex file to each transport channel.

35. The method as claimed in claim 27, wherein the transmit data streams are MIMO transmit data streams.

36. The method as claimed in claim 27, further comprising allocating a transport block table to each transmit data stream, which contains at least one transmission rate to be used for transmitting the transmit data stream.

37. The method as claimed in claim 27, further comprising:
determining a maximum available transmission capacity per transmit data stream based on available transmitting power per transmitting antenna and transmission characteristics determined for the at least one mobile radio channel of the respective transmitting antenna allocated thereto; and
performing the multiplexing, taking into consideration the maximum available transmission capacity per transmit data stream.

38. The method as claimed in claim 37, further comprising performing a prioritization of the transmit data streams based on the maximum available transmission capacity determined for each transmit data stream, wherein the highest priority is assigned to the transmit data stream having the greatest maximum available transmission capacity and lower priorities are assigned to the other transmit data streams in accordance with their respective maximum available transmission capacities determined, and wherein the number of priorities is less than or equal to the number of transmit data streams taken into consideration.

39. The method as claimed in claim 27, wherein the multiplexing is performed using a medium access control device provided with a scheduler unit.

40. The method as claimed in claim 39, further comprising:
providing the maximum transmission capacity available for each transmit data stream taking into consideration by the scheduler unit; and
processing, by the scheduler unit, the transmit data streams depending on the priority of the respective transmit data stream, beginning with the transmit data stream having the highest priority.

41. The method as claimed in claim 27, further comprising deactivating at least one transmit data stream or reactivating at least one transmit data stream.

42. The method as claimed in claim 27, further comprising deactivating at least one transmit data stream and reactivating at least one transmit data stream.

43. The method as claimed in claim 27, further comprising mapping the transmit data streams on to at least one physical data channel.

44. The method as claimed in claim 27, further comprising transmitting at least a part of the following information to the receiver of the transmit data stream for each transmit data stream: a number of the transmit data stream, information about a modulation method used, information about a coding method used, a transport block size indicator, a transport channel identity, and a number of transport blocks per transport channel.

45. The method as claimed in claim 27, being used in a cellular mobile radio communications system.

46. The method as claimed in claim 45, being used in a cellular 3GPP mobile radio communications system or in a 3GPP2 mobile radio communications system.

47. The method as claimed in claim 46, being used in a UMTS mobile radio communications system, in a CDMA2000 mobile radio communications system, or in a FOMA mobile radio communications system.

48. A method for demultiplexing transmit data streams received via a plurality of receiving antennas in a communications system having a plurality of transmitting antennas and the plurality of receiving antennas, comprising:
demultiplexing the received transmit data streams to form a plurality of data streams, wherein at least one transport channel is allocated to each data stream and each data stream has at least one data packet, using demultiplexing information transmitted by the transmitter and received via the receiving antennas, which information specifies a manner in which the data streams have been multiplexed on to the transmit data streams.

49. A transmitting device for transmitting a plurality of data streams, wherein at least one transport channel is allocated to each data stream and each data stream has at least one data packet, via a plurality of transmitting antennas in a communications system having the plurality of transmitting antennas and a plurality of receiving antennas, comprising:
a multiplexer multiplexing the data packets to transmit data streams; and
a multiplexer control unit controlling the multiplexing in accordance with a multiplexing rule stored in at least one multiplex file.

50. A receiving device for demultiplexing transmit data streams received via a plurality of receiving antennas in a communications system having a plurality of transmitting antennas and the plurality of receiving antennas, comprising:
a demultiplexer demultiplexing the received transmit data streams to form a plurality of data streams, wherein at least one transport channel is allocated to each data stream and each data stream has at least one data packet; and
a demultiplexer control unit controlling the demultiplexing in accordance with demultiplexing information transmitted by the transmitter and received via of the receiving antennas, in which a manner is specified, in which the data streams have been multiplexed on to the transmit data streams.

51. A computer program element for transmitting a plurality of data streams, wherein at least one transport channel is allocated to each data stream and each data stream has at least one data packet, via a plurality of transmitting antennas in a communications system having the plurality of transmitting antennas and a plurality of receiving antennas, which, when executed by a processor, comprises:
multiplexing the data packets on to transmit data streams for transmission via a respective transmitting antenna, wherein each transmit data stream is allocated to a transmitting antenna, the respective transmit data stream is transmitted via its associated transmitting antenna, and the multiplexing is effected by means of a multiplexing rule stored in at least one multiplex file.

52. A computer program element for demultiplexing transmit data streams received via a plurality of receiving antennas in a communications system having a plurality of transmitting antennas and the plurality of receiving antennas, which, when executed by a processor, comprises:
demultiplexing the received transmit data streams to form a plurality of data streams, wherein at least one transport channel is allocated to each data stream and each data stream has at least one data packet, using demultiplexing information transmitted by the transmitter and received via the receiving antennas, which specifies a manner in which the data streams have been multiplexed on to the transmit data streams.

53. A transmitting device for transmitting a plurality of data streams, wherein at least one transport channel is allocated to each data stream and each data stream has at least one data packet, via a plurality of transmitting antennas in a communications system having the plurality of transmitting antennas and a plurality of receiving antennas, comprising:
a multiplexing means for multiplexing the data packets to transmit data streams; and
a multiplexer control means for controlling the multiplexing in accordance with a multiplexing rule stored in at least one multiplex file.

54. A receiving device for demultiplexing transmit data streams received via a plurality of receiving antennas in a communications system having a plurality of transmitting antennas and the plurality of receiving antennas, comprising:
a demultiplexing means for demultiplexing the received transmit data streams to form a plurality of data streams, wherein at least one transport channel is allocated to each data stream and each data stream has at least one data packet; and
a demultiplexer control means for controlling the demultiplexing in accordance with demultiplexing information transmitted by the transmitter and received via of the receiving antennas, in which a manner is specified, in which the data streams have been multiplexed on to the transmit data streams.
